(19) United States
(12) Patent Application Publication
(10) Pub. No.: US 2020/0034935 A1
(43) Pub. Date: Jan. 30, 2020

(54) SYSTEM AND METHOD FOR INTELLIGENT SUBSIDENCE RISK ANALYSIS USING GIS DATA

(71) Applicant: MediaAgility Inc, Princeton, NJ (US)

(72) Inventor: Nilesh Chavda, London (GB)

(73) Assignee: MediaAgility Inc, Princeton, NJ (US)

(21) Appl. No.: 16/520,983

(22) Filed: Jul. 24, 2019

Related U.S. Application Data
(60) Provisional application No. 62/702,370, filed on Jul. 24, 2018.

(51) Int. Cl. G06Q 40/08; G06Q 50/16

(52) U.S. Cl. CPC G06Q 40/08; G06N 5/04; G06Q 50/163

(57) ABSTRACT

Disclosed are systems and a method for intelligent subsidence risk analysis using GIS data. More specifically the intelligent subsidence risk analysis using GIS data includes vegetation data. In one aspect, GIS data is used to analyze vegetation (trees) in the vicinity of the real estate property. Based on the vegetation, estimate of soil can also be done and combining the vegetation data, soil data and other data overall subsidence risk is estimated. As per yet another aspect of the disclosure, GIS data is obtained using commercial mapping systems and combined with public data.

### RELATED APPLICATIONS

This Application claims priority benefit of U.S. Provisional application No. 62/702,370, filed Jul. 24, 2018, which is incorporated entirely herein for all purpose.

### FIELD

The present disclosure generally relates to the field of real estate insurance. More specifically, the disclosure relates to property or/and building insurance and further to subsidence risk analysis using GIS (Geographical Information System) data for a real estate property.

### BACKGROUND ART

Property insurance provides protection against most risks to property, such as fire, theft and some weather damage. This includes specialized forms of insurance such as fire insurance, flood insurance, earthquake insurance, home insurance, or boiler insurance. Property is insured in two main ways: open perils and named perils. Open perils cover all the causes of loss not specifically excluded in the policy. Common exclusions on open peril policies include damage resulting from earthquakes, floods, nuclear incidents, acts of terrorism, and war. Named perils require the actual cause of loss to be listed in the policy for insurance to be provided. The more common named perils include such damage-causing events as fire, lightning, explosion, and theft.

Real estate/property insurance policies include various factors which determine the decision to issue a policy or not and also the premium for a particular property. Property Surveyors, insurance companies, insurance policy issuers, the underwriters, the brokers, and also the owners of the policies—the real estate owners, all are impacted by the policy factors.

In the prior art, there are various such risk factors listed include but are not limited to: fire hazard, presence of water bodies, earthquake zone, historical weather conditions, neighborhood conditions, etc. One important factor is subsidence risk. This is related to caving in of soil/foundation of the property. Subsidence risk is complex to accurately underwrite for insurance claims management and fraud detection.

Subsidence risk itself depends on multiple factors such as the Earthquake data, Weather data, Lightning data, Land registry, Infill data, Mining data, Vibration data, Roofing data, Building materials and age, Cavity walls, Water table geo-data, etc. Another two factors which are important are vegetation data and soil data. Vegetation i.e. trees have had reasonable impact on soil erosion and stability of the property. Tree type & root data, Tree canopy data, and impact on soil. On the other hand, soil composition itself has impact on the stability of the property.

US20030078733A1: “Method of determining subsidence in a reservoir” talks about prediction of subsidence using simulated data. Another reference: US 20160320479A1 elaborates the “Method for extracting ground attribute permanent scatter in interferometry synthetic aperture radar data”, in which specifically radar data use is discussed.

The following reference elaborates the importance of trees in home insurance in reasonable detail. http://www.gocompare.com/home-insurance/trees/

US20120072239A1 depicts “System and method for providing a home history report” in which a system for creating a report is mentioned public information from publicly available data sources and private information from a private date source, each of which is based upon input from a user; an interface to an retrieve insurance quote based upon the input, wherein the server is further configured to generate a report comprising the public information and private information and the insurance quote.

U.S. Pat. No. 9,213,461 elaborates “Web-based real estate mapping system” wherein an innovative web-based tool displays visual information about real estate. In one example, an aerial image is overlaid with various data layers to visually present real estate data. Associated can include tax parcel information, historical sales information, Multiple Listing Service information, school information, neighborhood information, and park information.

US20080208637A1 depicts “Method and System for Assessing Environmental Risk Associated with Parcel of Real Property” wherein disclosed are a system and method for assessing environmental risk associated with a parcel of real property through the form of reports which can be generated without the significant expense and time delay of a physical site inspection.

The main reason for the home owners not to disclose information about trees, vegetation in general is that they perceive this as impacting the premium and liability going up. It is definitely in the interest of the insurance company to know the risk before the policy is issued.

In view of the above prior art, there is a need to evolve an actionable intelligence using available GIS data and mapping it onto real estate specific information to evolve a subsidence risk. There is no reference in the prior art where GIS parameters for a real estate are identified for vegetation and used for subsidence calculation. Secondly there is no mention or reference of mapping this subsidence propensity gleaned from GIS data onto historically available data of the real estate. Thirdly, there is no mention of intelligent subsidence risk analysis.

### SUMMARY OF THE INVENTION

The present disclosure describes systems and a method for intelligent subsidence risk analysis using GIS data.

In an exemplary mode of the disclosure, GIS data is used to analyze the risk of subsidence. In one aspect, GIS data is used to analyze vegetation (trees) in the vicinity of the property. Based on the vegetation, estimate of soil can also be done and combining the vegetation data, soil data and other data overall subsidence risk is estimated.

As per yet another aspect of the disclosure, GIS data is obtained using commercial mapping systems and combined with public data.

### BRIEF DESCRIPTION OF THE DRAWINGS

For a more complete understanding of the present invention and the advantages thereof, reference is now made to the following descriptions taken in connection with the accompanying drawings in which:

FIG. 1 explains a system (100) for intelligent subsidence risk analysis using GIS data;

FIG. 2 depicts a flowchart for a method (200) for intelligent subsidence risk analysis using GIS data, in which one or more steps of the logic flow can be mapped to various system blocks of system (100) of FIG. 1;

FIG. 3 depicts a system (300) with a memory and a processor configured for intelligent subsidence risk analysis using GIS data, wherein the memory and the processor are functionally coupled to each other.

### DETAILED DESCRIPTION OF THE EMBODIMENTS

The present disclosure describes a system and method for intelligent subsidence risk analysis using GIS data.

The system could also be a computer readable medium, functionally coupled to a memory, where the computer readable medium is configured to implement the exemplary steps of the method. The system can be implemented as a stand-alone solution, as a Software-as-a-Service (SaaS) model or a cloud solution or any combination thereof.

Subsidence is mainly caused by soil shrinkage and that in turn may be affected by the moisture in the soil varying due to roots of the trees around the real estate property.

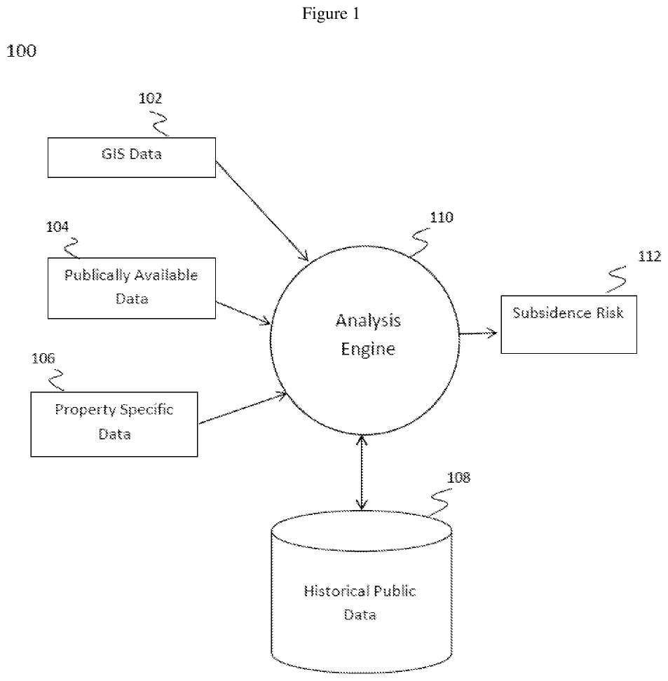

Referring to FIG. 1, various elements of system (100) for intelligent subsidence risk analysis using GIS data for a real estate property are described. The system (100) further comprises the GIS data (102) associated with the real estate property, which can be obtained using commercially available mapping tools. One such exemplary GIS tool is ‘Google Maps™’. The GIS data (102) comprises vegetation data associated with the real estate property. The commercially available mapping tools can help obtain the vegetation data such as the information about the specific trees in the vegetation surrounding the real estate property. Based on the trees and the distances between the trees and the boundaries of the property walls, external walls, fences, patios and pools, which are also obtainable using the same or similar tools, many conclusions could be drawn. As an example, we could look at the type of the tree and make an estimate about the “Zone of Influence” (ZoI). ZoI is an indicator as to how wide might be the spread of the roots from the tree trunk. Generally speaking, the greater the height of the tree, more is the ZoI. Ash, willow, elm, poplar and oak trees all consume a great deal of water and also have a much larger ZoI. This in turn is useful to gauge if the walls of the real estate property are endangered. Another estimate could be made is that of branch structure. Alternatively, it may even be observed using the same GIS tool. Branch structure also gives another data point for the stability of the real estate property. Yet another aspect of the invention is about being able to make an estimate about the soil type that supports the trees observed. This can also be synchronized with the data from other available sources.

The system (100) further comprises the publicly available data (104) that may in an exemplary manner include Land registry, soil data, water table information about the property. Some examples are if the soil is Cohesive, Clay, Silt, Peat, Chalk, Limestone, Sand, Gravel etc. Also included is the data on parameters of the soil such as its volumetric change, and plasticity index.

The system (100) further comprises the property specific data (106) and in an exemplary manner may include building material data, age of the real estate property, infill data, mining data and roofing data. The property specific data (106) may also store social data, for example, crime, safety data etc. The same data can be collected using IoT devices placed at the property.

The system (100) further comprises the historical public data (108) storing information, such as, but not limited to, weather data, seismic data, wind data, lightening data etc. The historical public data can be based on data gathered from at least one data source selected from the group consisting of historical land use databases, environmental agency recorded pollution incident databases, sites determined as contaminated land databases, landfill site databases, environmental agency waste site databases, current industrial sites databases, radioactive substance licenses databases, water industry referrals databases, dangerous substance inventory sites databases, licensed discharge consents databases, petroleum and fuel site databases, dangerous or hazardous sites databases, floodwaters databases, natural subsidence databases, radon affected areas databases, mining databases (including coal, and other mineral substances) groundwater vulnerability databases, soil leaching potential databases, government designated property databases, river quality databases, and databases representing combinations thereof. The historic public data (108) can also be further used for finding patterns, such as but not limited to, identifying clusters of properties with similar background, or similar subsidence risks or both.

The system (100) further comprises the analysis engine (110) that is configured to:
map and use a subset of the combination of the GIS data (102), publicly available data (104), property specific data (106) and historical public data (108); and
compute and generate a subsidence risk (112) based on the mapping and the using.

The analysis engine (110) configured for the mapping and the using a subset of the combination of the GIS data (102), publicly available data (104), property specific data (106) and historical public data (108), employs methods selected from a set comprising statistical methods, numerical methods, expert systems based methods, artificial intelligence based methods, machine learning methods and any combination thereof.

The system (100) in accordance with the present invention is deployable across a plurality of platforms using heterogeneous server and storage farms spread across geographies for better availability and high response time. The system is deployable using multiple hardware and integration options, such as, for example, solutions mounted on mobile hardware devices, third-party platforms and system solutions etc. The system (100) can be implemented as a stand-alone solution, as a Software-as-a-Service (SaaS) model or a cloud solution or any combination thereof.

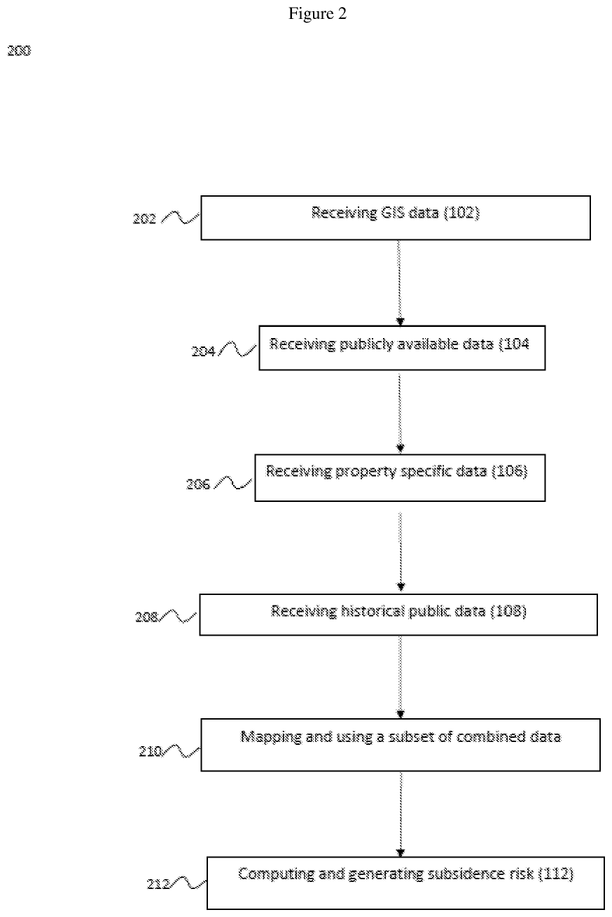

We now refer to FIG. 2 which describes a flowchart for the method (200) of intelligent subsidence risk analysis using GIS data for a real estate property, in which one or more steps of the logic flow can be mapped to various system blocks of system (100) of FIG. 1. Thus the method (200) is consistent with the system (100) described in FIG. 1, and is explained in conjunction with components of the system (100).

Step (202) describes receiving the GIS data (102) associated with the real estate property. The GIS data (102) comprises vegetation data associated with the real estate property. Step (204) further describes receiving publicly available data (104) associated with the real estate property and then step (206) describes receiving property specific data (106) associated with the real estate property. The method (200) further includes the step (208) depicting receiving historical public data (108) associated with the real estate property.

Step (210) describes the mapping and the using a subset of the combination of the GIS data (102), publicly available data (104), property specific data (106) and historical public data (108) and further step (212) describes computing and generating the subsidence risk (112) based on the mapping and the using.

The mapping and the using of step (210) employ a subset from the combination of the GIS data (102), publicly available data (104), property specific data (106) and historical public data (108), and employ methods selected from a set comprising statistical methods, numerical methods, expert systems based methods, artificial intelligence based methods, machine learning methods and any combination thereof; and

The step of (210) of the mapping, the using and the step (212) of computing are performed by the analysis engine (110).

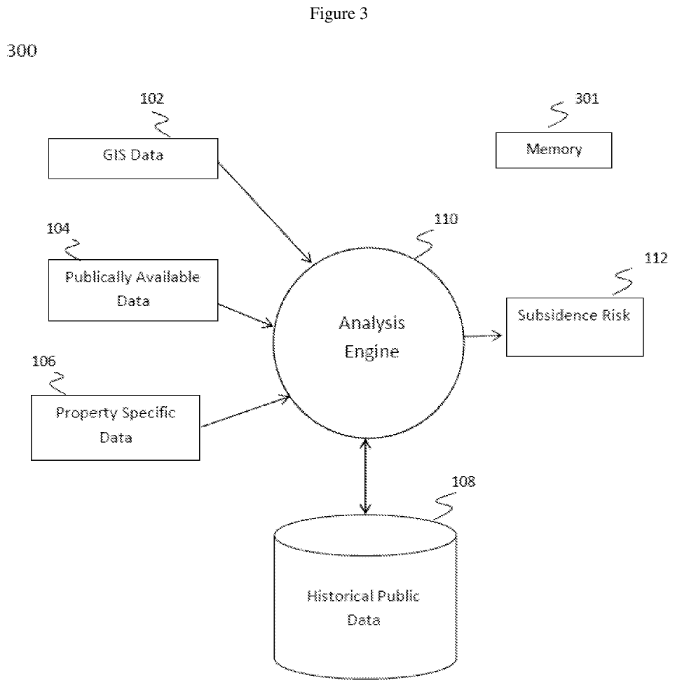

FIG. 3 depicts a system (300) with a memory (301) and a processor configured for intelligent subsidence risk analysis using GIS data for a real estate property, wherein the memory (301) and the processor are functionally coupled to each other. The processor of system (300) is configured to carry out the step (202) to step (212) of FIG. 2.

Referring to FIG. 3, various elements of system (300) for intelligent subsidence risk analysis using GIS data for a real estate property are described. The system (300) further comprises the GIS data (102) associated with the real estate property, which can be obtained using commercially available mapping tools. One such exemplary GIS tool is ‘Google Maps™’. The GIS data (102) comprises vegetation data associated with the real estate property. The commercially available mapping tools can help obtain the vegetation data such as the information about the specific trees in the vegetation surrounding the real estate property. Based on the trees and the distances between the trees and the boundaries of the property walls, external walls, fences, patios and pools, which are also obtainable using the same or similar tools, many conclusions could be drawn. As an example, we could look at the type of the tree and make an estimate about the “Zone of Influence” (ZoI). ZoI is an indicator as to how wide might be the spread of the roots from the tree trunk. Generally speaking, the greater the height of the tree, more is the ZoI. Ash, willow, elm, poplar and oak trees all consume a great deal of water and also have a much larger ZoI. This in turn is useful to gauge if the walls of the real estate property are endangered. Another estimate could be made is that of branch structure. Alternatively, it may even be observed using the same GIS tool. Branch structure also gives another data point for the stability of the real estate property. Yet another aspect of the invention is about being able to make an estimate about the soil type that supports the trees observed. This can also be synchronized with the data from other available sources.

The system (300) further comprises the publicly available data (104) that may in an exemplary manner include Land registry, soil data, water table information about the property. Some examples are if the soil is Cohesive, Clay, Silt, Peat, Chalk, Limestone, Sand, Gravel etc. Also included is the data on parameters of the soil such as its volumetric change, and plasticity index.

The system (300) further comprises the property specific data (106) and in an exemplary manner may include building material data, age of the real estate property, infill data, mining data and roofing data. The property specific data (106) may also store social data eg. crime, safety data etc.

The system (300) further comprises the historical public data (108) storing information, such as, but not limited to, weather data, seismic data, wind data, lightening data etc. The historic public data (108) can also be used for finding patterns, such as but not limited to, identifying clusters of properties with similar background, or similar subsidence risks or both.

The system (300) further comprises the analysis engine (110) that is configured to:
map and use a subset of the combination of the GIS data (102), publicly available data (104), property specific data (106) and historical public data (108); and
compute and generate a subsidence risk (112) based on the mapping and the using.

The analysis engine (110) configured for mapping and using a subset of the combination of the GIS data (102), publicly available data (104), property specific data (106) and historical public data (108), employs methods selected from a set comprising statistical methods, numerical methods, expert systems based methods, artificial intelligence based methods, machine learning methods and any combination thereof.

Thus, the systems (100) and (300) and the method (200) in accordance with the present disclosure are deployable across a plurality of platforms using heterogeneous server and storage farms spread across geographies for better availability and high response time.

The systems (100) and (300) and the method (200) are deployable using multiple hardware and integration options, such as, for example, cloud infrastructure, standalone solutions mounted on mobile hardware devices, third-party platforms and system solutions etc. and is advantageously facilitated to be validated using biometric and electric verifications like e-KYC (Know Your Customer).

There are several advantages of the method (200) and the systems (100) and (300), for intelligent subsidence analysis using GIS data. One advantage is the ease of getting access to data by using the GIS tools, rather than having to physically go to the real estate property. This saves time and other resources. Another advantage is the accuracy and efficiency of predicting the risk of subsidence since making estimates about the soil and water seepage is very much aided by information about trees surrounding the real estate property. Yet another advantage is not only lesser reliance on the information provided by the real estate property owner, which may be prone to error or willful concealment, but also the fact that more accurate information from GIS makes calculation of subsidence risk more accurate and hence premiums can be proportionately decided, making issuance of the policy less risky.

1. A system (100) for intelligent subsidence risk analysis using GIS data for a real estate property, the system (100) comprising GIS data (102) associated with the real estate property.

2. The system (100) of claim 1, wherein the GIS data (102) comprises vegetation data associated with the real estate property.

3. The system (100) of claim 1, further comprising publicly available data (104) associated with the real estate property.

4. The system (100) of claim 3, further comprising property specific data (106) associated with the real estate property.

5. The system (100) of claim 4, further comprising historical public data (108) associated with the real estate property.

6. The system (100) of claim 5, further comprising an analysis engine (110) configured to map and use a subset of the combination of the GIS data (102), the publicly available data (104), the property specific data (106) and the historical public data (108); and configured to compute and generate a subsidence risk (112) based on mapping and using of the subset of the combination of the GIS data (102), the publicly available data (104), the property specific data (106) and the historical public data (108).

7. The system (100) of claim 6, wherein the analysis engine (110) employs methods selected from a set comprising statistical methods, numerical methods, expert systems based methods, artificial intelligence based methods, machine learning methods, and any combination thereof.

8. A method (200) for intelligent subsidence risk analysis using GIS data for a real estate property, the method (200) comprising receiving GIS data (102) associated with the real estate property.

9. The method (200) of claim 8, wherein the GIS data (102) comprises vegetation data associated with the real estate property.

10. The method (200) of claim 8, further comprising receiving publicly available data (104) associated with the real estate property.

11. The method (200) of claim 10, further comprising receiving property specific data (106) associated with the real estate property.

12. The method (200) of claim 11, further comprising receiving historical public data (108) associated with the real estate property.

13. The method (200) of claim 12, further comprising steps of:
mapping and using a subset of the combination of the GIS data (102), the publicly available data (104), the property specific data (106) and the historical public data (108); and
computing and generating a subsidence risk (112) based on the mapping and the using of the subset of the combination of the GIS data (102), the publicly available data (104), the property specific data (106) and the historical public data (108).

14. The method (200) of claim 13, wherein the mapping and the using step employs methods selected from a set comprising statistical methods, numerical methods, expert systems based methods, artificial intelligence based methods, machine learning methods, and any combination thereof; and the mapping, the using and the computing and the generating steps are performed by an analysis engine (110).

15. A system (300) for intelligent subsidence risk analysis using GIS data for a real estate property, the system (300) comprising at least a processor and a memory (301), wherein the memory (301) and the processor are functionally coupled to each other; and the system (300) further comprising GIS data (102) associated with the real estate property.

16. The system (300) of claim 15, wherein the GIS data (102) comprises vegetation data associated with the real estate property.

17. The system (300) of claim 15, further comprising publicly available data (104) associated with the real estate property.

18. The system (300) of claim 17, further comprising property specific data (106) associated with the real estate property.

19. The system (300) of claim 18, further comprising historical public data (108) associated with the real estate property.

20. The system (300) of claim 19, further comprising an analysis engine (110) functionally coupled to the processor and the analysis engine (110) and configured to:
map and use a subset of the combination of the GIS data (102), the publicly available data (104), the property specific data (106) and the historical public data (108); and
compute and generate a subsidence risk (112) based on the mapping and using;
wherein the analysis engine (110) employs methods selected from a set comprising statistical methods, numerical methods, expert systems based methods, artificial intelligence based methods, machine learning methods and any combination thereof.
